(19) United States
(12) Patent Application Publication
(10) Pub. No.: US 2021/0095639 A1
(43) Pub. Date: Apr. 1, 2021

(54) A SYSTEM FOR GENERATING ELECTRICITY

(71) Applicants: Birudev Narayan HAJARE, Pune, Maharashtra (IN); Sandip Ankush BHOKSE, Pune, Maharashtra (IN)

(72) Inventors: Birudev Narayan HAJARE, Pune, Maharashtra (IN); Sandip Ankush BHOKSE, Pune, Maharashtra (IN)

(73) Assignees: Birudev Narayan HAJARE, Pune, Maharashtra (IN); Sandip Ankush BHOKSE, Pune, Maharashtra (IN); Deepak Vinodkumar SHAH, Erandwane, Pune (IN)

(21) Appl. No.: 16/635,395

(22) PCT Filed: Dec. 27, 2017
(86) PCT No.: PCT/IB2017/058406

§ 371 Date: Jan. 30, 2020

(30) Foreign Application Priority Data
Aug. 1, 2017 (IN) 201721027360

(51) Int. Cl. F03D 9/28; H02J 3/38; F03D 9/25

(52) U.S. Cl. CPC F03D 9/28; H02J 2300/28; F03D 9/25; H02J 3/381

(57) ABSTRACT

The present disclosure relates to a system for generating electricity. The system (100) comprises a compressed air source (102), an air speed enhancer (104), a plurality of pressure regulating units, a plurality of power generation units comprising a first power generation unit (108-114), at least one reducer (116), an exhaust arrangement (125). The first power generation unit comprises an air booster (108), a plurality of guide vanes (110), a turbine (112), and an electric generator (114). The exhaust arrangement (125) comprises an increaser (124), a second pressure regulating unit (126). The power generated from each of the power generation units is received in a bus bar (132). An input power (138) is given to the system (100) and an output power (140) is generated by the system (100).

### FIELD

The present disclosure relates to the field of electricity generation. More particularly, the present disclosure relates to a system used to generate electricity by using wind energy.

### BACKGROUND

The demand of electric power has exponentially increased with the increase in industrialization. In order to meet this ever growing demand of electric power, various renewable energy sources are used. Out of the available renewable energy sources, wind energy is a clean and an endless source of energy.

Conventional wind power generation systems rely upon natural uninterrupted flow of wind. The wind is used for powering a turbine which in turn generates the electric power. Further, a consistent flow of wind with a reasonable velocity is required for generating an optimum level of electric power. Typically, the availability of wind energy, at a particular location, is inherent and unpredictable. Due to such unpredictable nature of the flow of wind, the electric power generated by the conventional systems is unregulated. Further, one cannot rely upon such conventional systems which tend to generate insufficient electric power for catering higher power demand.

Therefore there is felt a need for a wind power generation system that alleviates the aforementioned drawbacks of the conventional system.

### OBJECTS

Some of the objects of the present disclosure, which at least one embodiment herein satisfies, are as follows:

An object of the present disclosure is to provide a system for generating electricity, which is independent of weather conditions.

Still another object of the present disclosure is to provide a system for generating electricity, which makes use of artificial wind energy to provide constant and continuous power generation.

Other objects and advantages of the present disclosure will be more apparent from the following description, which is not intended to limit the scope of the present disclosure.

### SUMMARY

The present disclosure envisages a system for generating electricity. The system for generating electricity comprises a compressed air source to supply air. An air speed enhancer is disposed downstream of the compressed air source and in fluid communication with the compressed air source for increasing the velocity of air current received from the compressed air source.

A first pressure regulating unit is disposed downstream of the air speed enhancer and is in fluid communication with the air speed enhancer for increasing the velocity of air current received from the air speed enhancer.

At least two power generation units are disposed downstream of the first pressure regulating unit and are in fluid communication with the first pressure regulating unit for receiving the high velocity air from the first pressure regulating unit and generate electricity therefrom.

At least one reducer is disposed operatively between two successive power generation units for increasing the velocity of air exiting the power generation unit and entering the subsequent power generation unit.

An exhaust arrangement is in fluid communication with last of the at least two power generation units for facilitating the discharge of air from the power generation units to the surrounding. In start-up condition, the compressed air source is operated via an external power supply until the system is operational, subsequent to which, the compressed air source is operated via system generated electric power.

In an embodiment, the power generation unit comprises an air booster that is in fluid communication with the first pressure regulating unit and is configured to reduce the volume of the air flow therethrough. A plurality of guide vanes is disposed downstream of the air booster and is configured to provide direction to the air flow. A turbine is disposed downstream of the plurality of guide vanes and is in fluid communication with the plurality of guide vanes. The turbine is configured to receive the directed air flow from the plurality of guide vanes. An electric generator is coupled with the turbine and is configured to receive mechanical drive from the turbine for generating electric power.

In another embodiment, the system further comprises at least one compressor that is in fluid communication with the turbine and the pressure regulator for preventing formation of back pressure therewithin.

In another embodiment, the exhaust arrangement comprises an increaser that is in fluid communication with the last of the power generation units, wherein the increaser is a diverging nozzle configured to reduce the velocity of air entering the increaser. A second pressure regulating unit is disposed downstream of the increaser, wherein the second pressure regulating unit is an exhaust means configured to discharge the air from the system to the surroundings.

In an embodiment, the system further comprises a bus bar that is coupled with the generators of the power generating units and a control panel, wherein the control panel is configured to control an electric supply to the system based on electric power generated via the power generation units.

The system further comprises a changeover switch that is coupled with the control panel. The changeover switch is configured to switch the power source for operating the system from external power supply to system generated power supply.

In an embodiment, the compressed air source may be an air blower. In another embodiment, the air blower is a motor operated blower. In an embodiment, the air speed enhancer has a conical shape. In another embodiment, the reducer has a decreasing cross sectional area which increases the pressure and velocity of the air.

### BRIEF DESCRIPTION OF THE ACCOMPANYING DRAWING

A system to generate electricity, of the present disclosure, will now be described with the help of the accompanying drawing, in which:

FIG. 1 illustrates the block diagram depicting the work stages of the system, in accordance with an embodiment of the present disclosure;

### LIST OF REFERENCE NUMERALS

100—System
102—Compressed Air Source
104—Air speed enhancer
106—First pressure regulating unit
108—First Air booster
109—First Power Generation Unit
110—Guide vanes
112—First turbine
114—First electric generator
116—First reducer
118—Second power generation unit
120—Third power generation unit
122—Fourth power generation unit
124—Increaser
125—Exhaust Arrangement
126—Second pressure regulating unit
128—Compressor
132—Bus bar
134—Control panel
136—Change over switch
138—Input power
140—Output power

### DETAILED DESCRIPTION

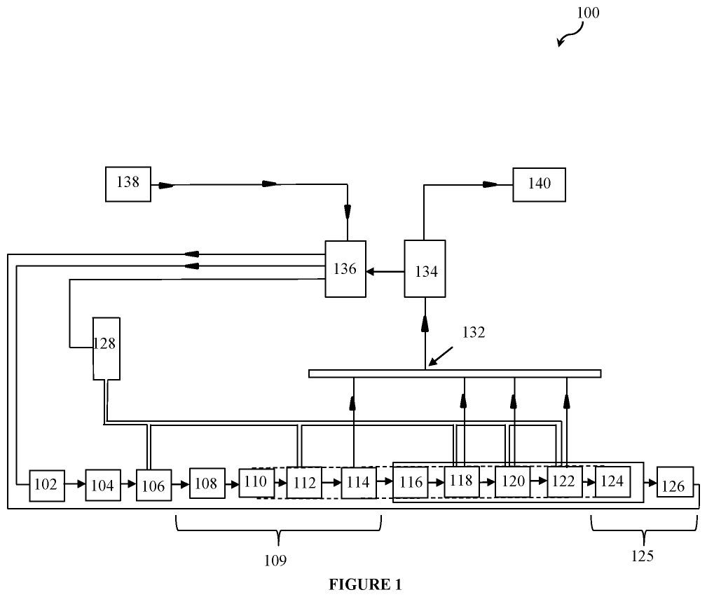

The system for generating electricity (herein after referred to as “system 100”) of the present disclosure is described with reference to FIG. 1.

The system 100 comprises a compressed air source 102, an air speed enhancer 104, a plurality of pressure regulating units, at least two power generation units, at least one reducer 116, and an exhaust arrangement 125.

The compressed air source 102 is an initiating means to supply air to the power generation unit at a pre-determined velocity. In an embodiment, the compressed air source 102 may be a motor operated air blower. The compressed air source 102 is configured to supply high pressure and high velocity air flow. Further, more than one compressed air source 102 can be provided to initiate the air supply in the system 100. In accordance with the present disclosure, the compressed air source 102, during start-up condition is operated via an external power supply, subsequent to which the compressed air source 102 is operated by the system generated electric power.

The air speed enhancer 104 is disposed downstream of the compressed air source 102 and is in fluid communication with the compressed air source 102. The air speed enhancer 104 is configured to increase the velocity of the air current received from the compressed air source 102. In an embodiment, the air speed enhancer 104 has a conical shape that facilitates the provision of a jet of air at its outlet with a much higher velocity compared to the velocity of air released from the compressed air source 102 at the inlet of the air speed enhancer 104.

A first pressure regulating unit 106 is disposed downstream of the air speed enhancer 104 and is in fluid communication with the air speed enhancer 104. The first pressure regulating unit 106 is configured to increase the velocity of air current received from the air speed enhancer 104. The first pressure regulating unit 106 comprises a plurality of nozzles disposed in a duct, wherein the velocity of air discharged from the nozzles can be varied as per the application requirement. As the air is discharged from the air speed enhancer 104, a low pressure zone is created within the air speed enhancer 104 (interchangeably referred as downstream pressure), as the pressure of the air at the outlet of the air speed enhancer 104 is comparatively lower that the pressure at the inlet of the air speed enhancer 104. Moreover, a back pressure is also created in the first pressure regulating unit 106, as the mass flow rate of the air to the downstream of the air speed enhancer 104 is not constant. To overcome this back pressure generated, the compressor 128 is coupled to the first pressure regulating unit 106. The inflow of the compressed air from the compressor 128 to the first pressure regulating unit 106 allows the air to flow at predetermined velocity, thereby preventing any back pressure.

The power generation units (109-122) are disposed downstream of the first pressure regulating unit 106 and are in fluid communication with the first pressure regulating unit 106. The power generation units (109-122) are configured to receive the high velocity air from the first pressure regulating unit 106 to generate electricity therefrom. The first power generation unit (108-114) is coupled to the first pressure regulating unit 106. The first power generation unit (108-114) comprises an air booster 108, a plurality of guide vanes 110, a turbine 112, and an electric generator 114. The air, with a reduced pressure, is discharged from the air speed enhancer 104 and is supplied to the first power generation unit (108-114) for harnessing the energy of the air. The turbine 112 is coupled to the air booster 108 via an air duct.

The first air booster 108 is in fluid communication with the first pressure regulating unit 106 and is configured to reduce the volume of air flow therethrough. Due to a decreased volume of air, it is characterized by a high pressure and a high velocity. The high pressure and high velocity air from the air booster 108 is supplied to the air duct, wherein the guide vanes 110 direct the air flow to the turbine 112. The turbine 112 is coupled with another pressure regulating unit 126 in connection with the compressor 128 to advance the flow of air to the subsequent power generation units, without creating any back pressure.

The plurality of guide vanes 110 are disposed downstream of the air booster 108 and are configured to provide direction to the air flow. The plurality of guide vanes 110 are provided within the air duct for directing the air onto a plurality of runner blades of the turbine 112 at a predetermined velocity.

The turbine 112 is disposed downstream of the plurality of guide vanes 110 and is in fluid communication with the plurality of guide vanes 110. The turbine 112 is configured to receive the directed air flow from the plurality of guide vanes 110. The turbine 112 is provided with a plurality of runner blades, wherein the pressure of the air is substantially reduced due to expansion of air along the runner blades of the turbine 112. Further, the turbine 112 is coupled with the first electric generator 114.

The first electric generator 114 is coupled with the turbine 112 and is configured to receive a rotary mechanical drive from the turbine 112 for generating the electric power.

Further, a bus bar 132 is coupled with the generators of the power generating units (109-122) and a control panel 134, wherein the control panel 134 is configured to control an electric supply to the system 100 based on electric power generated via the power generation units (109-122). Each of the power generation units (109-122) comprises an air booster 108, a plurality of guide vanes 110, a turbine 112, and an electric generator 114.

A first reducer 116 is disposed operatively between two successive power generation units for increasing the velocity of air exiting the power generation unit and entering the subsequent power generation unit. The air having reduced air pressure is supplied to the first reducer 116. The first reducer 116 has a decreasing cross sectional area that facilitates the provision of high pressure and high velocity air to the incoming air. This high pressure and high velocity air is supplied to a second air booster (not shown in figures) of a second power generation unit 118 to generate electric output. The air discharged from the second power generation unit 118 progresses to a third power generation unit 120 to generate electrical output. Similarly, the third power generation unit 120 and a fourth power generation unit 122 follow the suite to generate the electric power.

The exhaust arrangement 125 comprises an increaser 124, and a second pressure regulating unit 126. The increaser 124 is in fluid communication with the turbine 112 of the fourth power generation unit 122, the increaser 124 is a diverging nozzle configured to reduce the velocity of air entering the increaser 124. The second pressure regulating unit 126 is disposed downstream of the increaser 124, wherein the second pressure regulating unit 126 is an exhaust means (not shown in figure). The exhaust means is configured to discharge the air from the system 100 to the surroundings. In an embodiment, the exhaust means may be an exhaust fan.

Further, a change over switch 136 is coupled with the control panel 134. The change over switch 136 is configured to switch the power source for operating the system 100 from external power supply to system generated power supply. The changeover switch 136 is connected to the compressed air source 102, the compressor 128 and the second pressure regulating unit 126, wherein the changeover switch 136 is configured to control an input supply power 138. When the system 100 generates a predetermined amount of power, the changeover switch 136 cuts off the external power supply.

The system 100 works independently once the changeover switch 136 cuts off the external power supply. Further, the system 100 of the present disclosure is self-sufficient, after the system 100 becomes operational. It is to be noted subsequent to the start-up condition.

Further, the pressure maintained throughout the system 100 is more than 1 bar, i.e., the atmospheric pressure. More specifically, the atmospheric air is supplied to the system 100 via the compressed air source 102 and additional compressed air from the compressor 128 is supplied to the required components such as the pressure regulating units, the turbines, and the power generating units, thereby preventing the formation of back pressure in the system. Furthermore, the pressure inside the system 100 before each turbine 112 is greater than the downstream pressure after the turbine 112, thereby increasing the velocity of air passing therethrough.

In one example, the system 100 requires 600 kW of input power 138 to operate optimally. The power generated from each of the power generation units of the system 100 is 400 kW. Further, the total output generated by the system 100 is 1600 kW. However, out of the 1600 kW output power 140 generated by the system 100, 600 kW is utilized to run the components of the system 100 such as the compressor 128, the motor to initiate to drive the compressed air source 102, and each of the pressure regulating units. Each pressure regulating unit consumes 90 kW to operate. The blower motor consumes 180 kW to drive the compressed air source 102. The Compressor 128 consumes 275 kW to run. Moreover, the power required to operate control panel 134 and other components of the system 100 is 55 kW. As such, the net output power of the system 100 is about 1000 kW. The values mentioned are considered to be approximate values. The range of the power generated and consumed by the components can be varied and is not limited to the abovementioned values.

Therefore, an artificially generated air flow is used to generate electric power, of the present disclosure that eliminates the limitations to use conventional wind energy for electric power generation.

### Technical Advancements

The present disclosure described herein above has several technical advantages including, but not limited to, the realization of a system for generating electricity that:
is independent of weather conditions;
makes use of artificial wind energy to provide constant and continuous electric power generation; and

The embodiments as described herein above, and various features and advantageous details thereof are explained with reference to the non-limiting embodiments in the description. Descriptions of well-known aspects, components and molecular biology techniques are omitted so as to not unnecessarily obscure the embodiments herein.

The foregoing description of specific embodiments so fully reveal the general nature of the embodiments herein, that others can, by applying current knowledge, readily modify and/or adapt for various applications of such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein. Further, it is to be distinctly understood that the foregoing descriptive matter is to be interpreted merely as illustrative of the disclosure and not as a limitation.

Having described and illustrated the principles of the present disclosure with reference to the described embodiments, it will be recognized that the described embodiments can be modified in arrangement and detail without departing from the scope of such principles.

While considerable emphasis has been placed herein on the particular features of this disclosure, it will be appreciated that various modifications can be made, and that many changes can be made in the preferred embodiment without departing from the principles of the disclosure. These and other modifications in the nature of the disclosure or the preferred embodiments will be apparent to those skilled in the art from the disclosure herein, whereby it is to be distinctly understood that the foregoing descriptive matter is to be interpreted merely as illustrative of the disclosure and not as a limitation.

1. A system (100) for generating electricity, said system (100) comprising:
a compressed air source (102);
an air speed enhancer (104) disposed downstream of said compressed air source (102) and in fluid communication with said compressed air source (102) for increasing the velocity of air current received from said compressed air source (102);
a first pressure regulating unit (106) disposed downstream of said air speed enhancer (104) and in fluid communication with said air speed enhancer (104) for increasing the velocity of air current received from said air speed enhancer (104);
at least two power generation units disposed downstream of said first pressure regulating unit (106) and in fluid communication with said first pressure regulating unit (106) for receiving the high velocity air from said first pressure regulating unit (106) and generate electricity therefrom;
at least one reducer (116) disposed operatively between two successive power generation units for increasing the velocity of air exiting said power generation unit and entering the subsequent power generation unit;
an exhaust arrangement (125) in fluid communication with last of said at least two power generation units for facilitating discharge of air from said power generation units to the surroundings;
wherein, in start-up condition, said compressed air source (102) is operated via an external power supply until said system is operational, subsequent to which, said compressed air source (102) is operated via system generated electric power.

2. The system (100) as claimed in claim 1, wherein said power generation unit comprises:
an air booster (108) in fluid communication with said first pressure regulating unit (106) and is configured to reduce the volume of air flow therethrough;
a plurality of guide vanes (110) disposed downstream of said air booster (108) and configured to provide direction to the air flow;
a turbine (112) disposed downstream of said plurality of guide vanes (110) and in fluid communication with said plurality of guide vanes (110), said turbine (112) configured to receive the directed air flow from said plurality of guide vanes (110); and
an electric generator (114) coupled with said turbine (112) and is configured to receive rotary mechanical drive from said turbine (112) for generating electric power.

3. The system (100) as claimed in claim 2, further comprising at least one compressor (128) in fluid communication with said turbine (112) and said pressure regulator (106) for preventing formation of back pressure there within.

4. The system (100) as claimed in claim 1, wherein said exhaust arrangement 125 comprises:
an increaser (124) in fluid communication with the last of said power generation units, said increaser (124) is a diverging nozzle configured to reduce the velocity of air entering said increaser (124); and
a second pressure regulating unit (126) disposed downstream of said increaser (124), wherein said second pressure regulating unit (126) is an exhaust means configured to discharge the air from the system to the surroundings.

5. The system (100) as claimed in claim 1, further comprising a bus bar (132) wherein said bus bar (132) is coupled with the generators (114) of said power generating units and a control panel (134), wherein said control panel (134) is configured to control an electric supply to said system (100) based on electric power generated via said power generation units.

6. The system (100) as claimed in claim 4, further comprising a changeover switch (136) coupled with said control panel (134), said changeover switch (136) configured to switch the power source for operating said system (100) from external power supply to system generated power supply.

7. The system (100) as claimed in claim 1, wherein said compressed air source (102) is a motor operated blower.

8. The system (100) as claimed in claim 1, wherein said air speed enhancer (104) has a conical shape.

9. The system (100) as claimed in claim 1, wherein said reducer (116) has a decreasing cross sectional area which increases pressure and velocity of the air.
